(19) United States
(12) Patent Application Publication
(10) Pub. No.: US 2007/0059233 A1
(43) Pub. Date: Mar. 15, 2007

(54) Carbon material having high surface area and conductivity and preparation method thereof

(76) Inventors: Kyou-Yoon Sheem, Yongin-si (KR); Sung-Soo Kim, Yongin-si (KR); Young-Hee Lee, Suwon-si (KR); Young-Seak Lee, Daejeon-si (KR)

Correspondence Address: CHRISTIE, PARKER & HALE, LLP, PO BOX 7068, PASADENA, CA, 91109-7068, US

(21) Appl. No.: 11/515,372

(22) Filed: Aug. 31, 2006

(30) Foreign Application Priority Data
Aug. 31, 2005 (KR) 10-2005-0080605

(51) Int. Cl. C01B 31/00

(52) U.S. Cl. 423/445 R; 428/408; 502/427

(57) ABSTRACT

Provided are carbon materials having a high specific surface area and high conductivity, and a preparation method thereof. The carbon material includes pores on the surface and inside, with channels connecting the pores to one another. Such carbon material has a high specific surface area and high conductivity, and can be used in a number of diverse fields. Exemplary uses include use as an electric double layer capacitor (EDLC), as a catalyst supporter of a fuel cell, as an electrode conductive material of a rechargeable lithium battery, and as an adsorption agent.

### CROSS-REFERENCE TO RELATED APPLICATION

This application claims priority to and the benefit of Korean Patent Application No. 10-2005-0080605 filed in the Korean Intellectual Property Office on Aug. 31, 2005, the entire content of which is incorporated herein by reference.

### BACKGROUND

1. Field of the Invention

The present invention relates to a carbon material that has a high specific surface area and high conductivity, and a method for preparing the carbon material.

2. Description of the Related Art

Carbon materials may be divided into amorphous carbon and crystalline carbon according to their crystalline properties.

Amorphous carbon has a low graphitization degree or shows few diffraction lines in X-ray diffraction. Examples of amorphous carbon include petroleum-based pitch, soft carbon produced by firing petroleum-based pitch, and hard carbon produced by firing a polymer resin such as phenol resin.

Examples of crystalline carbon include natural graphite and artificial graphite.

Since the above-mentioned carbon materials have high conductivity, they are used as conductive materials for batteries, and they have recently been used as a catalyst supporter for a fuel cell.

### SUMMARY OF THE INVENTION

One embodiment of the present invention provides a carbon material having a high specific surface area and high conductivity.

Another embodiment of the present invention provides a method for preparing a carbon material having a high specific surface area and high conductivity.

According to an embodiment of the present invention, a porous carbon material includes pores on the surface and pores inside, where the pores are connected by channels.

According to an embodiment of the present invention, a method for preparing a carbon material includes: mixing a carbon precursor and a pore-forming material in a solvent to produce a mixture; spinning the mixture to produce a fiber; treating the fiber with an acid or an alkali to remove the pore-forming material from the fiber and produce a porous fiber; and heat treating the porous fiber.

### BRIEF DESCRIPTION OF THE DRAWINGS

FIG. 1 is a cross-sectional view showing a porous carbon fiber in accordance with an embodiment of the present invention;

FIG. 2 is a scanning electron microscope (SEM) photograph showing a 3,000× magnification of porous carbon fiber prepared in accordance with Example 1 of the present invention;

FIG. 3 is a SEM photograph showing a cross-section of the porous carbon fiber of FIG. 2 at 50,000× magnification;

FIG. 4 is a SEM photograph showing a 2,000× magnification of porous carbon fiber prepared in accordance with Example 1 of the present invention;

FIG. 5 is a SEM photograph showing a 30,000× magnification of porous carbon fiber prepared in accordance with Example 5 of the present invention.

### DETAILED DESCRIPTION

An embodiment of the present invention will hereinafter be described in detail with reference to the accompanying drawings.

Carbon materials with conductive properties are generally used as conductive materials in various fields. The present invention provides a method for preparing a carbon material with improved conductivity.

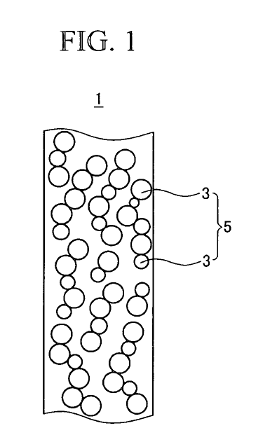

FIG. 1 shows a cross-section of a carbon fiber in accordance with an embodiment of the present invention. Referring to FIG. 1, the carbon material 1 of the present invention is a porous carbon material having pores 3 both on the surface and inside, with groups of pores connected to one another to form a channel 5. The porous carbon material includes carbon fiber having a scaffold structure.

The porous carbon material has an X-ray diffraction pattern measured using a CuKα ray. In an embodiment, an X-ray diffraction intensity 2θ of a (002) plane ranges from 3.3 Å to 4.5 Å, and is preferably from 3.3 Å to 4.0 Å, more preferably from 3.3 Å to 3.6 Å, and even more preferably from 3.3 Å to 3.5 Å at 260. When the X-ray diffraction intensity of the carbon material is less than 3.3 Å, the carbon material cannot perform the role of the carbon material adequately. When it exceeds 4.5 Å, the conductivity of the carbon material tends to deteriorate to an undesirable level.

The carbon material may further include a pore-forming material. In such an embodiment, the XRD 20 has a peak of the pore-forming material at 26° together with a carbon peak.

In an embodiment, the carbon material of the present invention may have a Raman strength ratio D/G (I₁₃₆₀/I₁₅₈₀) of the peak value at 1360 cm⁻¹ to the peak value at 1580 cm⁻¹ ranging from 0.1 to 2.0.

In an embodiment, the carbon material of the present invention may have a very high specific surface area, and may have a Brunauer, Emmett, Teller Method (BET) value, of less than or equal to 2,500 m²/g, and the value preferably ranges from 100 m²/g to 2,500 m²/g, and more preferably ranges from 100 m²/g to 2,000 m²/g. Exemplary uses of such a carbon material include use as an electric double layer capacitor (EDLC), as a catalyst supporter for a fuel cell, as an electrode conductive material for a rechargeable lithium battery, and as an adsorption agent.

In an embodiment, the average diameter of the carbon material may range from 100 nm to 30 μm. It is difficult to prepare a carbon material having an average diameter of less than 100 nm, and when the average diameter of the carbon material exceeds 30 μm, the surface area generally becomes too small to be useful.

The carbon material of an embodiment of the present invention may be provided as a fiber or an amorphous micro fine powder prepared by pulverizing the carbon fiber.

In one embodiment, the carbon material of the present invention can be prepared as follows.

A carbon precursor is mixed with a pore-forming material. The mixing may be performed in a solvent, or it may be performed after dissolving the carbon precursor in a solvent first to form a solution and then adding the pore-forming material to the carbon precursor solution.

Examples of the carbon precursor include polyacrylonitrile, polybenzimidazole, polyvinylalcohol, polyimide, coal pitch, petroleum pitch, mesophase pitch, furfuryl alcohol, furan, phenol, cellulose, sucrose, polyvinyl chloride, and tar.

The pore-forming material may be a material that is not dissolved in the solvent but that may be removed after a spinning process as set forth in further detail below. Examples of the pore-forming material include Si oxides, Al oxides, NaCl, and microemulsion polymer beads. For an embodiment using microemulsion polymer beads, the polymer may be a material that can be prepared in the form of a fine powder. Representative examples of the polymer are styrene-based materials such as styrene butadiene rubber.

In an embodiment, the average particle size of the pore-forming material is between 5 nm and 1 μm, which is larger than an average particle size of the carbon material.

The solvent is capable of dissolving the carbon precursor but not dissolving the pore-forming material. Examples of the solvent include organic solvents such as dimethylformaldehyde, N-methylpyrrolidone, tetrahydrofuran, and chloroform, and water.

In an embodiment, the mixing ratio of the carbon precursor to the pore-forming material may range from 99 to 5:1 to 95 by weight, and is preferably from 99 to 10:1 to 90 by weight, and more preferably from 70 to 30:30 to 70 by weight. When the carbon precursor is provided in a ratio greater than 99:1, the desired porosity may not be obtained. When the carbon precursor is provided in a ratio less than 5:1, the final product may not have the desired properties.

In an embodiment, a carbon precursor fiber is prepared by spinning the acquired mixture. The spinning process may be performed using an electrostatic spinning method, a melt spinning method, a melt blown carbon spinning method, an electrospray method, or a spray drying method.

In embodiments of the present invention, the carbon precursor may be selected to produce different shapes of the carbon precursor fiber which may include a spherical ball shape or a conventional long fiber shape.

The fiber may is treated with an acid or alkali to remove the pore-forming material. By removing the pore-forming material using an acid or alkali treatment, the pores are formed in the fiber. The pores are also connected to each other to form channels in order to produce a porous carbon fiber. An exemplary acid is hydrofluoric acid (HF), and an exemplary alkali is sodium hydroxide (NaOH). The acid or alkali treatment is performed by impregnating the fiber in an acid or alkali solution for from 1 to 48 hours.

Oxygen stabilization may be also performed prior to the acid or alkali treatment. Oxygen stabilization is a process of thermal oxidation treatment performed in the atmosphere at 200° C. to 400° C. for 1 to 24 hours. In the process, the molecular structure of the carbon precursor fiber molecules is stabilized by doping the carbon precursor fiber molecules with oxygen to maintain its fiber shape in the subsequent high-temperature heat treatment.

According to an embodiment of the invention, the acid or alkali treatment is followed by carbonization. The carbonization may be carried out in an inert gas at 800° C. to 1,500° C. for 1 to 12 hours. After the carbonization, a graphitization process may be further carried out. The graphitization process may be performed at 2,000° C. to 3,300° C. for 1 to 12 hours.

According to an embodiment, the resulting fiber-type carbon material may then be pulverized into a fine powder.

Hereinafter, examples and comparative examples of the present invention will be described. However, it is understood that the present invention is not limited by these examples.

### EXAMPLE 1

A 10 wt % polyacrylonitrile solution was prepared by dissolving polyacrylonitrile in dimethylformaldehyde. Silica powder was added to the 10 wt % polyacrylonitrile solution in the same weight as the polyacrylonitrile. The solution was agitated, and carbon fiber was prepared by electrostatic spinning.

The prepared carbon fiber was stabilized using oxygen stabilization to produce a polyacrylonitrile structure. The oxygen stabilization was performed at about 250° C. for about 5 hours. The resultant material obtained from the oxygen stabilization was impregnated with HF acid and maintained for a day to remove silica from the carbon fiber. The carbon fiber with the silica removed was heated in a nitrogen atmosphere at 1,000° C. for one hour to produce porous carbon fiber.

### EXAMPLE 2

The same process as in Example 1 was performed, except that 20 wt % polybenzimidazole solution was prepared by dissolving polybenzimidazole in dimethylacetamide and skipping the oxygen stabilization process.

### EXAMPLE 3

The same process as in Example 1 was performed, except that a 20 wt % pitch solution was prepared by dissolving pitch in tetrahydrofuran.

### EXAMPLE 4

The same process as in Example 1 was performed, except that a 20 wt % pitch solution was prepared by dissolving pitch in tetrahydrofuran, and silica powder was added to the pitch solution in an amount of 90 wt % of the pitch.

### EXAMPLE 5

The same process as in Example 1 was performed, except that silica powder was added to pitch in the same weight and melt spinning was performed.

### COMPARATIVE EXAMPLE 1

The same process as in Example 1 was performed except that silica powder was not added.

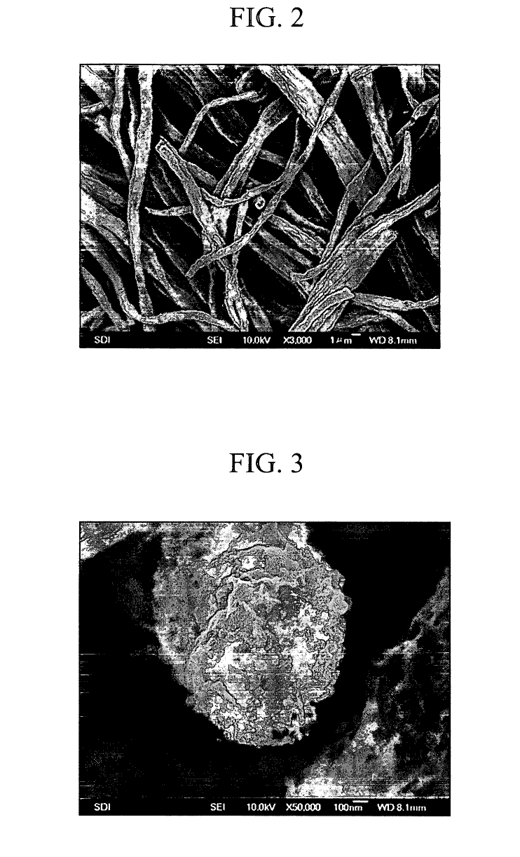

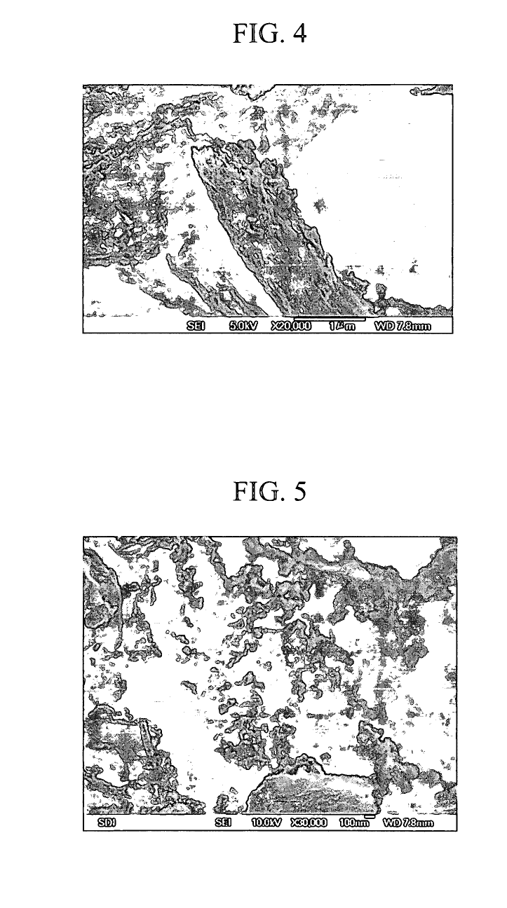

FIG. 2 shows a 3,000× magnification scanning electron microscope (SEM) photograph of the porous carbon fiber prepared in accordance with Example 1, and FIG. 3 shows a broken cross-section thereof at 50,000× magnification. Also, FIG. 4 shows a 2,000× magnification SEM photograph of the porous carbon fiber prepared in accordance with Example 1. As shown in FIGS. 2 to 4, the porous carbon fiber exists in a form such that many fibers are entangled with each other and the inside of the carbon fiber has pores. As can be seen from FIG. 4, the carbon fiber has a sponge structure at its cross-section and also has a scaffold structure.

FIG. 5 shows a 30,000× magnification SEM photograph showing a cross-section of the broken porous carbon fiber prepared in accordance with Example 5. The photograph shows that spherical hollow spaces are formed as the silica is removed.

Since the carbon material of the present invention has a high specific surface area and high conductivity, it can be applied to diverse fields, such as an electric double layer capacitor (EDLC), a catalyst supporter of a fuel cell, an electrode conductive material of a rechargeable lithium battery, and an adsorption agent.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A porous carbon material, comprising:
carbon with pores on its surface, internal pores, and a plurality of channels connecting a plurality of the pores.

2. The porous carbon material of claim 1, wherein the carbon material is a carbon fiber.

3. The porous carbon material of claim 1, wherein the carbon material is a fine powder.

4. The porous carbon material of claim 1, wherein the porous carbon material has an X-ray diffraction pattern using a CuKα ray, and an X-ray diffraction intensity 2θ of a (002) plane ranging from 3.3 Å to 4.5 Å at 260.

5. The porous carbon material of claim 1, wherein the carbon material has a specific surface area less than or equal to 2,500 m²/g.

6. The porous carbon material of claim 5, wherein the specific surface area ranges from 100 m²/g to 2,500 m²/g.

7. The porous carbon material of claim 1, wherein the carbon material exhibits a Raman strength ratio D/G (I₁₃₆₀/I₁₅₈₀) of the peak value at 1360 cm⁻¹ to the peak value at 1580 cm⁻, ranging from 0.1 to 2.0.

8. The porous carbon material of claim 1, wherein the carbon material has an average diameter from 100 nm to 30 μm.

9. The porous carbon material of claim 1, further comprising a pore-forming material.

10. The porous carbon material of claim 9, wherein the pore-forming material is selected from the group consisting of oxides of Si, oxides of Al, NaCl, microemulsion polymer beads, and combinations thereof.

11. The porous carbon material of claim 1, wherein the carbon material is prepared by a method comprising:
mixing a carbon precursor and a pore-forming material in a solvent to produce a mixture;
spinning the mixture to produce a fiber;
treating the fiber with an acid or an alkali to remove the pore-forming material and produce a porous fiber; and
heat treating the porous fiber.

12. The porous carbon material of claim 1, wherein the carbon material is used as an electric double layer capacitor (EDLC), as a catalyst supporter of a fuel cell, as an electrode conductive material of a rechargeable lithium battery, or as an adsorption agent.

13. A method for preparing a carbon material, comprising:
mixing a carbon precursor and a pore-forming material in a solvent to produce a mixture;
spinning the mixture to produce a fiber;
treating the fiber with an acid or an alkali to remove the pore-forming material and produce porous fiber; and
heat treating the porous fiber.

14. The method of claim 13, wherein the carbon precursor is selected from the group consisting of petroleum-based pitch, coal pitch, polyimide, polybenzimidazole, polyacrylonitrile, mesophase pitch, furfuryl alcohol, furan, phenol, cellulose, sucrose, polyvinylchloride, and combinations thereof.

15. The method of claim 13, wherein the pore-forming material is selected from the group consisting of oxides of Si, oxides of Al, NaCl, microemulsion polymer beads, and combinations thereof.

16. The method of claim 13, wherein the carbon precursor and the pore-forming material are provided in a mixing ratio of from 99 to 5:1 to 95 by weight.

17. The method of claim 13, wherein the carbon precursor and the pore-forming material are provided in a mixing ratio of from 99 to 10:1 to 90 by weight.

18. The method of claim 13, wherein the carbon precursor and the pore-forming material are provided in a mixing ratio of from 70 to 30:3 to 70 by weight.

19. The method of claim 13, wherein the spinning is carried out by a method selected from the group consisting of electrostatic spinning, melt spinning, melt blown carbon spinning, electrospray, and spray drying.

20. The method of claim 13, wherein the fiber is treated using hydrofluoric acid (HF).

21. The method of claim 13, wherein the fiber is treated using sodium hydroxide (NaOH).

22. The method of claim 13, wherein the heat treating is performed in an inert gas environment at a temperature ranging from 800° C. to 1,500° C. for 1 to 12 hours.

23. The method of claim 13, wherein the heat treating comprises:
carbonizing the porous fiber in an inert gas at a temperature ranging from 800° C. to 1,500° C. for 1 to 12 hours; and
graphitizing the carbonized porous fiber in an inert gas at a temperature ranging from 2,000° C. to 3,300° C. for 1 to 12 hours.

24. The method of claim 13, further comprising oxidizing the porous carbon fiber at 200° C. to 400° C. prior to the acid or alkali treatment.
